(19) United States
(12) Patent Application Publication
(10) Pub. No.: US 2007/0205081 A1
(43) Pub. Date: Sep. 6, 2007

(54) Turntable

(75) Inventors: Senzo Kyutoku, Mie (JP); Tatsuo Tsubaki, Mie (JP); Masanao Murata, Mie (JP)

Correspondence Address: DRINKER BIDDLE & REATH (DC), 1500 K STREET, N.W., SUITE 1100, WASHINGTON, DC, 20005-1209, US

(73) Assignee: Asyst Shinko, Inc.

(21) Appl. No.: 11/705,508

(22) Filed: Feb. 13, 2007

(30) Foreign Application Priority Data
Feb. 14, 2006 (JP) P.2006-036588

(51) Int. Cl. B65G 47/24

(52) U.S. Cl. 198/373

(57) ABSTRACT

A turntable has a plurality of intra-table tracks, each of which includes inlet and outlet end portion that is capable of communicating with a carrying-in and carrying-out side of the transporting track, respectively, wherein an object is transported from the inlet end portion to the outlet end portion, a table member on which the intra-table tracks are provided, a table rotating mechanism that rotates the table member to be stopped at an arbitrary rotation angle and a table rotation controlling mechanism. The table rotation controlling mechanism controls the rotation of the table member so as to set the transport direction of the transporting object transported through the intra-table tracks. The intra-table tracks are disposed in the table member so that when a transport direction of one of the intra-table tracks is set, the inlet end portion of any other intra-table tracks communicates with the carrying-in side of the transporting track.

### BACKGROUND OF THE INVENTION

1. Field of the Invention

The present invention relates to a turntable which changes a transport direction of a transporting object.

2. Description of Related Art

Conventionally, this kind of apparatus is disclosed, for example, in Japanese Patent Unexamined Publication JP-T-2003-506289. More specifically, a rail member is provided in a direction changing part changing a direction of a carrying-in track so as to be pivotable, whereby one end portion of the rail member matches with a carrying-in track at a carrying-in side at the time of a rotation attitude of a carrying-in angle and the other end portion of the rail member matches with a carrying-in track at a carrying-out side at the time of a rotation attitude of a carrying-out angle. By this configuration, in a known turntable, it becomes possible that an object is transported with keeping its attitude to the carrying-in track by changing the pivoting of the rail member to the carrying-in angle and the carrying-out angle.

However, in a known configuration, after carrying-out a transporting object by changing a rotation attitude of a rail member from a carrying-in angle to a carrying-out angle and changing a transport direction of the transporting object, a restoring operation for restoring the rotation attitude of the rail member from the carrying-out angle to the carrying-in angle is required when changing the transport direction of a succeeding transporting object. There is a problem that this restoring operation generates a standby time at the time of changing a traveling direction of the succeeding transporting object, whereby a start timing of changing the traveling direction of the transporting object may be delayed.

### SUMMARY OF THE INVENTION

Therefore, it is an object of the invention to provide a turntable capable of starting to turn the traveling direction of the transporting object.

According to a first aspect of the invention, there is provided a turntable which changes a transport direction of a transporting object transported through a transporting track, comprising:

a plurality of intra-table tracks, each of which comprising:
an inlet end portion that is capable of communicating with a carrying-in side of the transporting track; and
an outlet end portion that is capable of communicating with a carrying-out side of the transporting track,
wherein the transporting object is transported from the inlet end portion to the outlet end portion;

a table member on which the intra-table tracks are provided;

a table rotating mechanism that rotates the table member to be stopped at an arbitrary rotation angle; and

a table rotation controlling mechanism that controls the rotation of the table member so as to set the transport direction of the transporting object transported through the intra-table tracks,

wherein the intra-table tracks are disposed in the table member so that when a transport direction of one of the intra-table tracks is set, the inlet end portion of any other intra-table tracks communicates with the carrying-in side of the transporting track.

By this configuration, when the transport direction of the intra-table track is set by rotating the table member, the outlet end portion of the intra-table track communicates with the carrying-out side of the transporting track corresponding to the transport direction of the transporting object. The transport direction of the intra-table track is changed and the transporting object of the intra-table track is carried out to the transporting track existing at the carrying-out side (the downstream side of the transport direction), whereby it is possible to change the transport direction of the transporting object. At this time, the inlet end portion of any other intra-table tracks communicates with the carrying-in side of the transporting track when the transport direction is set. Accordingly, even though a previous restoring operation of restoring the intra-table track to a pre-setting status of the transport direction is not performed, an operation of changing the transport direction can be commenced in a short time by carrying-in the next transporting object existing at the carrying-in side of the transporting track into the intra-table track.

According to a second aspect of the invention, as set forth in the first aspect of the invention, it is preferable that the intra-table tracks comprise a plurality of track blocks each comprising:

a first track transporting the transporting object;

a second track transporting the transporting object in a direction intersecting the transport direction of the first track; and

a track elevating mechanism that selectively elevates the first track and the second track,

wherein the intra-table tracks are formed by a combination of the track blocks.

By this configuration, since it is possible to easily complete an arrangement work of the intra-table track by the combination of the track blocks and to intersect the intra-table tracks, it is possible to miniaturize the turntable. Even when the intra-table tracks intersect each other, the first track and the second track not used for the transportation may move down to a position lower than the second track or the first track used for the transportation. Accordingly, it is possible to prevent the both tracks from being the obstacle in the transportation of the transporting object.

According to a third aspect of the invention, it is preferable that the turntable as set forth in the first aspect of the invention, further comprising a transport controlling mechanism that controls so that:

detecting a completion of setting the transport direction of a preceding transporting object carried in the intra-table tracks,

carrying-in a succeeding transporting object into the intra-table tracks, and simultaneously, transporting the preceding transporting object to the outside of the turntable just after the setting is completed.

By this configuration, when the completion of the setting of the transport direction on the intra-table track is detected, the preceding transporting object and the succeeding transporting object can be carried in and out with respect to the turntable at the same time. By this configuration, it becomes possible to resolve a standby time which is caused by a mismatch of a carrying-in timing and a carrying-out timing, thereby improve a transport efficiency in the turntable in that the succeeding transporting object can be carried in the turntable when the preceding transporting object exists in the turntable.

According to a fourth aspect of the invention, there is provided a turntable which changes a transport direction of a transporting object transported through a transporting track, comprising:

a plurality of intra-table tracks, each of which comprising:
an inlet end portion that is capable of communicating with a carrying-in side of the transporting track; and
an outlet end portion that is capable of communicating with a carrying-out side of the transporting track,
wherein the transporting object is transported from the inlet end portion to the outlet end portion;

a table member on which the intra-table tracks are provided;

a table rotating mechanism that rotates the table member; and

a table rotation controlling mechanism that controls in such a manner that:
carring in the transporting object from the carrying-in side of the transporting track to the inlet end of one of the intra-table tracks;
rotating the table member so that the outlet end of one of the intra-table tracks is positioned at the carring-out side of the transporting track, and the inlet end of another intra-table tracks is positioned at the carring-in side of the transporting track.

According to a fifth aspect of the invention, as set forth in the fourth aspect of the invention, it is preferable that the intra-table tracks comprise a plurality of track blocks each comprising:

a first track transporting the transporting object;

a second track transporting the transporting object in a direction intersecting the transport direction of the first track; and

a track elevating mechanism that selectively elevates the first track and the second track,

wherein the intra-table tracks are formed by a combination of the track blocks.

According to a sixth aspect of the invention, it is preferable that the turntable as set forth in the fifth aspect of the invention, further comprising a transport controlling mechanism that controls so that:

detecting a completion of the rotating of the table member,

carrying-in a succeeding transporting object into the another intra-table tracks, and simultaneously, transporting a preceding transporting object to the carrying-out side of the transporting track just after the rotation of table member is completed.

### BRIEF DESCRIPTION OF THE DRAWINGS

FIG. 1 is a schematic configuration view of a transport system;

FIG. 2 is an explanatory view illustrating a transport status of a turntable;

FIG. 3 is a schematic configuration view of a track block;

FIG. 4 is an explanatory view illustrating a transport status of a turntable;

FIG. 5 is an explanatory view illustrating a transport status of a turntable;

FIG. 6 is a schematic configuration view of a rotation position detecting mechanism;

FIG. 7 is a block diagram of a table controlling device;

FIG. 8 illustrates a roller elevation data table;

FIG. 9 is a schematic configuration view of a turntable;

FIG. 10 is a flowchart of a table controlling routine;

FIG. 11 is an explanatory view illustrating a transport status of a turntable;

FIG. 12 is an explanatory view illustrating a transport status of a turntable;

FIG. 13 is a schematic configuration view of a turntable;

FIG. 14 is an explanatory view illustrating a transport status of a turntable;

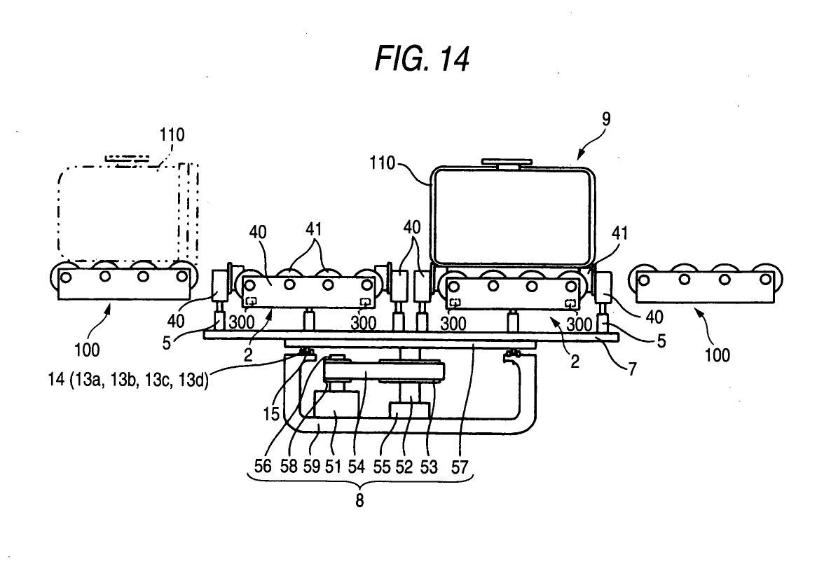

FIG. 15 is a flowchart of a table controlling routine; and

FIG. 16 is a schematic configuration view of a turntable.

### DETAILED DESCRIPTION OF EXEMPLARY EMBODIMENTS OF THE INVENTION EMBODIMENTS

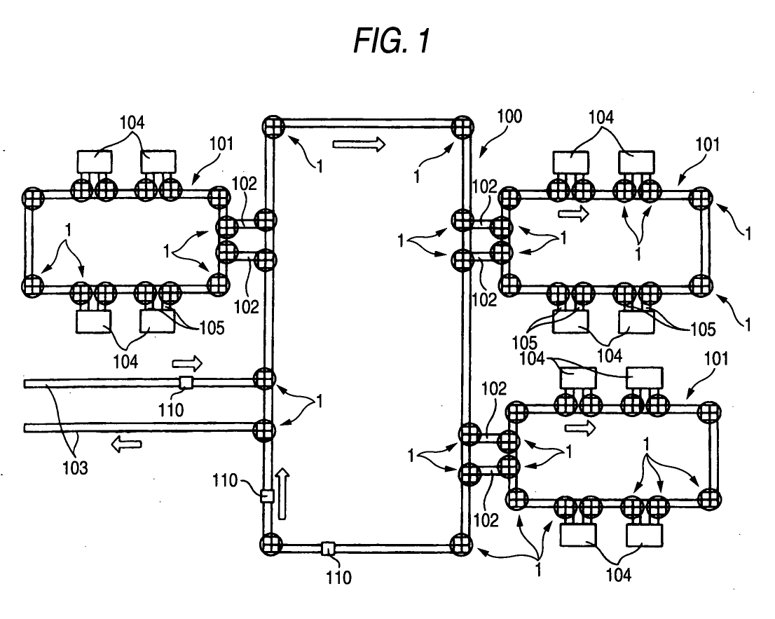

Embodiments of the invention will be described on the basis of FIGS. 1 to 12 as follows.

(Overview of Transport System)

A turntable according to the present embodiment has a configuration in which a transport direction of a carrier 110 (a transporting object) transported through a transporting track can be changed and is provided in a transport system shown in FIG. 1. The transport system includes an inter-process roller conveyor track 100 communicating between processes arranged in a predetermined area, an intra-process roller conveyor track 101 arranged in the periphery of the inter-process roller conveyor track 100, and a communication roller conveyor track 103 communicating other processes (including the inter-process roller conveyor track 100) not shown with the inter-process roller conveyor track 100.

The intra-process roller conveyor track 101 and the inter-process roller conveyor track 100 communicate with each other by a pair of inter-track ports 102. A plurality of semiconductor manufacturing equipments 104 is arranged in the periphery of the intra-process roller conveyor track 101. The intra-process roller conveyor track 101 and the semiconductor manufacturing equipment 104 communicate with each other by a pair of carrying-in and carrying-out ports 105. The tracks 100, 101, and 103 and the ports 102 and 105 constitute a transporting track transporting the carrier 110.

The inter-process roller conveyor track 100 and the intra-process roller conveyor track 101 have a rectangular shape as a whole in a top view. A turntable 1 holding and changing (by 90 degrees) the transport direction of the carrier 110 is provided in each corner portion of four edges on both tracks 100 and 101. A detailed description of the turntable 1 will be given later. By this configuration, an attitude of the carrier 110 to the tracks 100 and 101 is kept constant by changing the transport direction from an upstream side through a downstream side centering on the corner portion and the carrier 110 is circumferentially transported on the rectangular track 100 and 101.

The turntable 1 is provided in connectors between the tracks 103 and 100, and is provided in connectors between the tracks 100 and 101 and the ports 102 and 105. By this configuration, the carrier 110 may be orbitally transported on the same tracks 100 and 101 or may be transferred to other tracks 100, 101, and 103 by holding and changing the transport direction of the turntable 1. In the present embodiment, a case where the corner portions or the connectors of the tracks 100, 101, and 103 or the ports 102 and 105 serve as a direction changing part capable of changing the transport direction of the carrier 110 is described, but the other portions may be set as the direction changing part.

(Mechanical Configuration of Turntable 1)

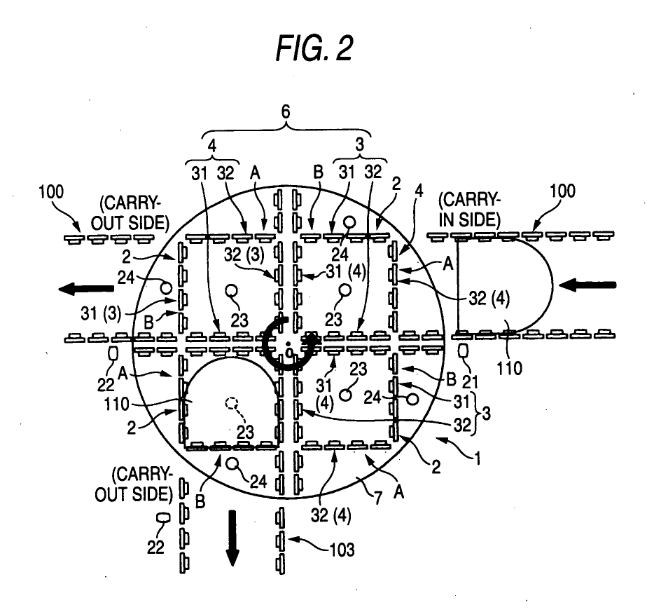

Each turntable 1 provided in the transport system has a rectangular track block 2 in a top view as shown in FIG. 2. The track block 2 includes a first track 3 transporting the carrier 110, a second track 4 transporting the carrier 110 in a direction orthogonal to a transport direction of the first track, and a track elevating mechanism 5 selectively lifting and elevating the first track 3 and the second track 4. Herein, a “selective elevation” represents an operation of lowering the other track when lifting any one of the first track 3 and the second track 4, and an operation of preventing the other track from being an obstacle in the transportation when transporting the carrier 110 through any one of the first track 3 and the second track 4.

The first and second tracks 3 and 4 each have a driving roller mechanism 31 and a driven roller 32 in pairs. The driving roller mechanism 31 and the driven roller mechanism 32 are disposed at both sides of a width direction (a direction orthogonal to the transport direction) of the carrier 110. The driving roller mechanism 31 supports one side of a width direction in a bottom portion of the carrier 110 and applies a driving force to move the carrier 110 in the transport direction to the carrier 110. Meanwhile, the driven roller mechanism 32 supports the other side in the bottom portion of the carrier 110 so as to be movable in the transport direction.

(Mechanical Configuration of Turntable 1: Driving Roller Mechanism 31 and Driven Roller Mechanism 32)

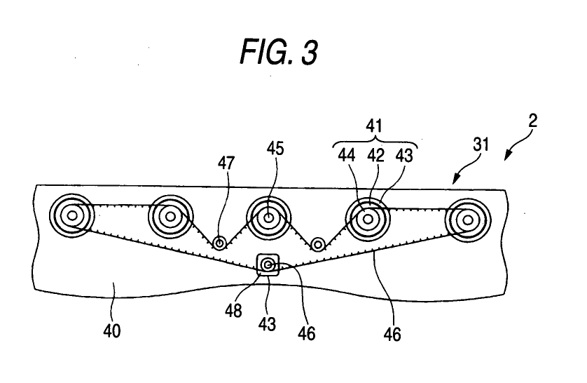

More specifically, the driving roller mechanism 31 has a roller supporting frame 40 disposed in the transport direction. The roller supporting frame 40 has a plurality of driving rollers 41 (five driving rollers in an example of FIG. 3) at a predetermined interval. The number of the driving rollers 41 may be changed depending on a length of the roller supporting frame 40.

As shown in FIG. 3, the driving roller 41 has a cargo receiving part 42, a flange 43, and a sprocket 44. The members 42, 43, and 44 are integrally inserted into and fixed to a roller shaft 45. The cargo receiving part 42 supports the bottom of the carrier 110 and transports the carrier 110 by rotating with the rotation of the sprocket 44. As a result, since a surface of the cargo receiving part 32 takes a sliding-prevention role by a high friction coefficient by softening an impact such as a vibration in the transportation of the carrier 110, the surface of the cargo receiving part 32 is coated with an urethane rubber. The flange 43 has a diameter larger than the cargo receiving part 32 and abuts on the carrier 110, thereby restricting a horizontal position thereof. The roller shafts 45 inserted into the five driving rollers 41 are axially fixed to the roller supporting frame 42 at even intervals so as to be pivotable.

The sprockets 44 each are axially fixed to front end portions of the roller shafts 45 inserted into the five driving rollers 41. A timing belt 46 is wound around each of the five sprockets 44. Similarly, as an intra-table roller driving motor 48 attached to a driving shaft 46 of the sprocket 44 wound by the timing belt 46 is pivotably driven, the sprocket 44 rotates. A tension roller 47 is provided in the timing belt 46 in abutment with a surface having no teeth on the timing belt 46 so as to apply a tension to the timing belt 46.

Meanwhile, the driven roller mechanism 32 has the same configuration as the above-mentioned driving roller mechanism 31 except for functions related to a driving operation. That is, the driven roller mechanism 32 has the same configuration as the driving roller mechanism 31 except for the sprocket 44, the driving shaft 46, and the tension roller 47.

(Mechanical Configuration of Turntable 1: Track Elevating Mechanism 5)

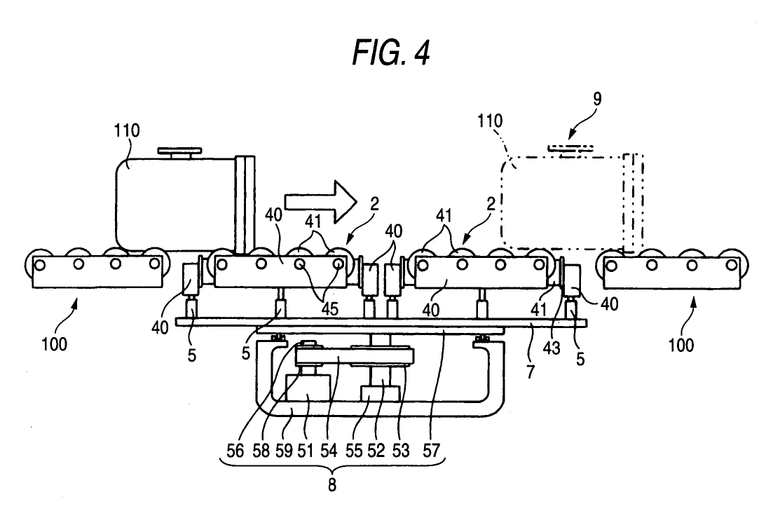

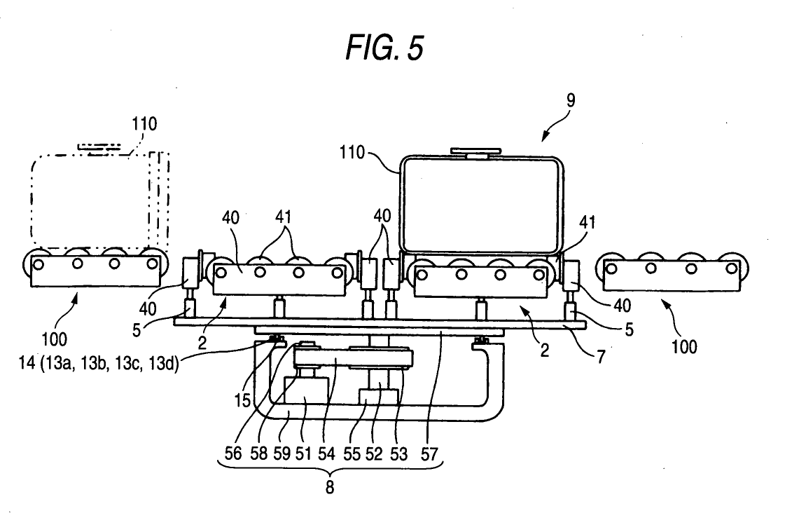

As shown in FIGS. 4 and 5, the driving roller mechanism 31 and the driven roller mechanism 32 are supported to be elevatable by the track elevating mechanism 5. The track elevating mechanism 5 is constituted by an electric motor, a cylinder apparatus such as an air cylinder, a compressor, and a solenoid valve. The track elevating mechanism 5 moves down the roller mechanisms 31 and 32 on the tracks 3 and 4 not used for the transportation to a position lower than the roller mechanisms 31 and 32 on the tracks 4 and 3 used for the transportation to prevent the both tracks 3 and 4 from serving as the obstacle in the transportation of the carrier 110.

More specifically, for example, as shown in FIG. 2, four track blocks 2, 2, 2, and 2 are disposed on the turntable 1 and the first track 3 and the second track 4 are arranged on each track block 2. The roller mechanisms 31 and 32 on the first track 3 and the second track 4 located in a direction intersecting the transport direction of the carrier 110 are disposed in an evacuation position lower than a transport height. Meanwhile, the roller mechanisms 31 and 32 of the first track 3 and the second track 4 located in a direction parallel to the transport direction of the carrier 110 are disposed in a transport height position.

Herein, the “transport height position” is a height position where the carrier 110 is transported by the tracks 100, 101, and 103 including the inter-roller conveyor track 100 and the communication roller conveyor track 103, or the ports 102 and 105. The “evacuation height position” is particularly not limited when it is a height position not contacting the bottom surface of the carrier 110.

(Mechanical Configuration of Turntable 1; Track Block 2 and Intra-table Track 6)

The track elevating mechanism 5, the first track 3, and the second track 4 constitute the track block 2. In the track block 2, the first track 3 (the roller mechanisms 31 and 32) is orthogonal to the second track 4 (the roller mechanisms 31 and 32) and both ends of the first track 3 (the roller mechanisms 31 and 32) and the second track 4 (the roller mechanisms 31 and 32) match with both ends of the track block 2. The first track 3 and the second track 4 constitute an end surface of the track block 2 and have the rectangular shape in a top view.

The four track blocks 2 are collectively arranged in a 2×2 matrix. The first track 3 and the second track 4 of the neighboring track blocks 2 and 2 constitute the intra-table track 6 so that end sections thereof face each other. By this configuration, an aggregate of the track blocks 2 has four intra-table tracks 6. The intra-table tracks 6 each are respectively arranged parallel to four faces of the aggregate. The intra-table tracks 6 are formed from one end to the other end of the aggregate of the track blocks 2. The one end of the intra-table track 6 is set as an inlet end portion A which can communicate with the carrying-in side of the transporting track such as the inter-process roller conveyor track 100. Meanwhile, the other end of the intra-table track 6 is set as an outlet end portion B which can communicate with the carrying-out sided of the transporting track. By this configuration, the aggregate of the track blocks 2 has the inlet end portion A and the outlet end portion B with a corner portion interposed therebetween, whereby it has the four inlet end portions A and the four outlet end portions B alternatively.

The aggregate of the track blocks 2 is provided on a top surface of the table member 7. A positional relationship between the aggregate of the track blocks 2 and the table member 7 is set so that center portions match with each other. A rotation center serves as the center portion of the table member 7. By this configuration, the aggregate of the track blocks 2 changes the transport direction of the intra-table track 6 by 90 degrees when the table member 7 rotates by 90 degrees, but it constantly locates the inlet end portion A and the outlet end portion B of other intra-table track 6 in the same location.

In the present embodiment, a case where the four track blocks 2 combined in 2 by 2 constitute the intra-table track 6 is described, but the invention is not limited to the case. That is, the combination or the arrangement of the track blocks 2 satisfies a condition that the inlet end portion A of any one intra-table track 6 is disposed to communicate with the carrying-in side of the transporting track when the transport direction of the intra-table track 6 is set. For example, the intra-table track 6 may be constituted by the track blocks 2 combined in 3 by 3, 4 by 4, n by n (n is a natural number) and in this case, it is possible to increase the number of the transporting tracks annexed depending on the number of lines and the number of rows.

(Mechanical Configuration of Turntable 1: Table Rotating Mechanism 8)

As shown in FIGS. 4 and 5, the center portion O of the table member 7 is pivotably supported by the table rotating mechanism 8. The table rotating mechanism 8 is constituted by a driving motor 51, a rotation shaft 52, a sprocket 53, a timing belt 54, a bearing 55, a motor shaft 56, a support member 57, a sprocket 58, and a support frame 59. The table member 7 is fixed to the rotation shaft 52 via an attachment member 57. The rotation shaft 52 is axially fixed to the support frame 59 to be pivotable by the bearing 55 in a lower portion thereof. The support frame 59 has a substantially U-shaped side cross-section surface and a substantially circular top cross-section surface. The sprocket (a pulley having a teeth) 53 axially fixed to the rotation shaft 52 is connected to the sprocket 58 axially fixed to the motor shaft 56 of the driving motor 51 fixed to the support frame 59 by the timing belt 54. The driving motor 51 is fixedly disposed on the support frame 59. The table rotating mechanism 8 configured as above transmits a rotation driving force of the driving motor 51 to the table member 7 via the timing belt 54 or the rotation shaft 52 to suspendingly rotate the table member 7 and the track block 2 (the intra-table track 6) provided on the table member 7 at an arbitrary rotation angle.

(Table Rotation Controlling Mechanism 9: Rotation Position Detecting Mechanism 10)

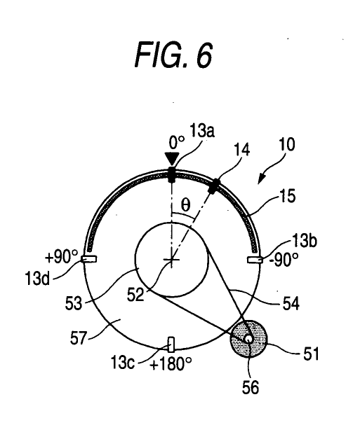

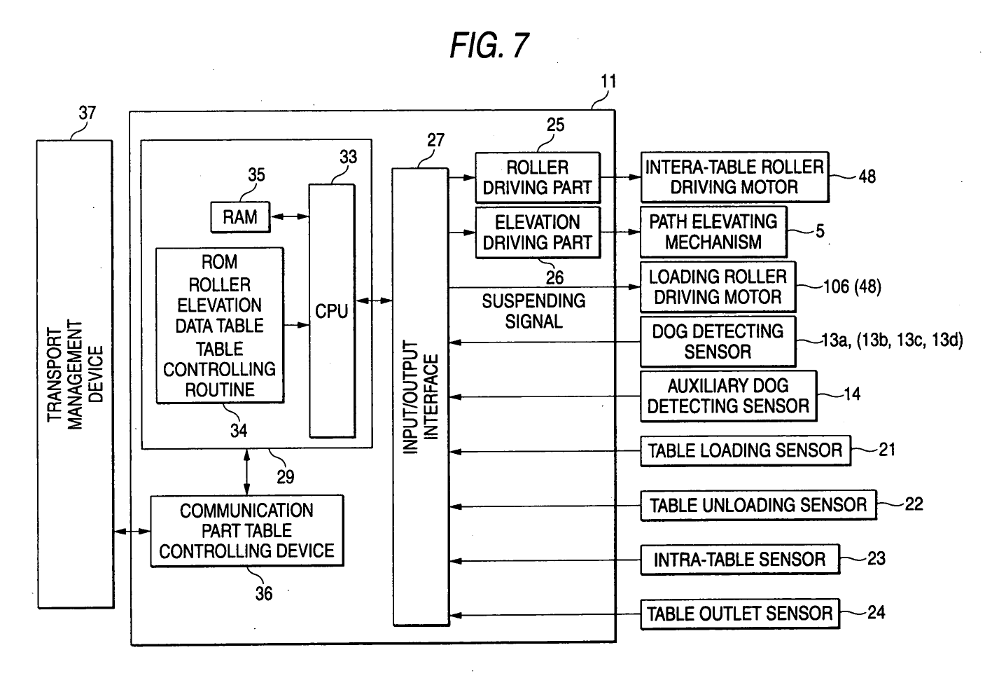

An operation of the table rotating mechanism 8 is controlled by the table rotation controlling mechanism 9. The table rotation controlling mechanism 9 includes the rotation position detecting mechanism 10 (FIG. 6) detecting a rotation angle of the table member 7 and a table controlling device 11 (FIG. 7) controlling a rotating operation or a transporting operation of the turntable 1.

As shown in FIG. 6, the rotation position detecting mechanism 10 has a shade plate 15 used for recognizing the rotation position (the rotation angle) of the table member 7, four shade plate detecting sensors 13a, 13b, 13c, and 13d, and one auxiliary shade plate detecting sensor 14 which detect the shade plate 15. The shade plate 15 is provided on a bottom surface of the support member 17. The shade plate 15 has a semi-circular shape curved along a periphery of the table member 7. A length of the shade plate 15 is a bit shorter than a half contour of the table member 7. The shade plate 15 is disposed so that the semi-circular center thereof is located in a front direction (an origin direction) of the turntable 1.

Meanwhile, the shade plate detecting sensors 13a, 13b, 13c, and 13d and the auxiliary shade plate detecting sensor 14 are provided in an upper edge portion of the support frame 59 facing the support member 57. The shade plate detecting sensors 13a, 13b, 13c, and 13d and the auxiliary shade plate detecting sensor 14 is photo sensors having a light emitting element and a light receiving element and the shade plate 15 is disposed between the light emitting element and the light receiving element. By this configuration, the detecting sensors 13a, 13b, 13c, 13d, and 14 do not detect the shade plate 15 when receiving light of the light emitting element to the light receiving element, while it detects the shade plate 15 when not receiving the light of the light emitting element to the light receiving element.

Specifically, the shade plate detecting sensors 13a, 13b, 13c, and 13d are arranged in an upper circumferential edge portion of the support frame 59 on extension lines of the corresponding parting lines quartering a center angle centering on the rotation shaft 52 serving as a rotation center of the table member 7. More specifically, the shade plate detecting sensor 13a is disposed in the upper circumferential edge portion of the support frame 59 at 0 degree position (an origin position) toward the carrying-in side of the transporting track. The shade plate detecting sensor 13b is disposed in the upper circumferential edge portion of the support frame 59 at −90 degrees spaced from the shade plate detecting sensor 13a by 90 degrees in a clockwise direction. The shade plate detecting sensor 13d is disposed in the upper circumferential edge portion of the support frame 59 at +90 degrees spaced from the shade plate detecting sensor 13a by 90 degrees in a counterclockwise direction. The shade plate detecting sensor 13c is disposed in the upper circumferential edge portion of the support frame 59 at +180 degrees spaced from the shade plate detecting sensor 13a by +180 degrees in a counterclockwise direction. The auxiliary shade plate detecting sensor 14 is disposed in the upper circumferential edge portion of the support frame 59 spaced from the shade plate detecting sensor 13a by a center angle θ in the clockwise direction.

As described above, the rotation position detecting mechanism 10 can precisely detect the rotation position when the rotation angle of the turntable 1 is 0 degree (the origin), +90 degrees, +180 degrees, or +270 degrees (−90 degrees) by detecting the shade plate 15 with five photo sensors of the shade plate detecting sensor 13a, 13b, 13c, and 13d and the auxiliary shade plate detecting sensor 14.

(Table Rotation Controlling Mechanism 9: Table Controlling Device 11)

The rotation position detecting mechanism 10 is used for controlling of the rotation operation of the turntable 1 with the table controlling device 11. The table controlling device 11 includes an information processing part 29, an input/output part 27 connected to the information processing part 29, a roller driving part 25 connected to the input/output part 27, and an elevation driving part 26. The information processing part 29 includes a RAM part 35 temporarily storing a variety of data, a ROM 34 storing the variety of data only for reading, a communication part 36 performing a data communicating operation with external devices, and a CPU part 33 executing a variety of programs including a table controlling routine, and the like. The ROM 34 part stores a variety of data tables including a roller elevation data table, and the like and stores the variety of programs including a table processing routine, and the like. A detailed description of the roller elevation data table and the table processing routine will be given later.

The communication part 36 is connected to a transport management device 37 so as to communicate with each other. A data communication type may be either wireless type or wired type and a variety of communication methods including Internet may be used for the data communication. The transport management device 37 has a variety of functions including a management function separately managing a transport status or a transport location of the carrier 110 in the transport system and a transport direction indicating function indicating the transport direction of each carrier 110 by the data communication with the table controlling device 11 of each turntable 1.

The input/output part 27 is connected to the roller driving part 25 and the elevation driving part 26 so as to output a control signal. The roller driving part 25 is connected to the intra-table roller driving motor 48. The roller driving part 25 has a function of suspending to supply a driving current to the intra-table roller driving motor 48 and a current switching function of supplying and suspending the driving current depending on the control signal. The elevation driving part 26 is connected to the track elevating mechanism 5. The elevation driving part 26 has a function of opening and closing the solenoid valve allowing the cylinder device not shown of the track elevating mechanism 5 to be elevated and a valve switching function of switching an opening state and a closing state of the solenoid valve depending on the control signal.

The input/output part 27 outputs a suspending signal for suspending the rotation operation to a roller driving motor 106 of the inlet track 100, 101, and 103 or the parts 102 and 105, or a control device controlling the rotation operation of the roller driving motor 106 (48). The suspending signal is output when the next carrier 110 is prevented from being carried in the turntable 1 like a case where the carrier 110 exists in the turntable 1.

The input/output part 27 is connected to the above-mentioned shade plate detecting sensors 13a, 13b, 13c, and 13d, and the auxiliary shade plate detecting sensor 14 and is connected to a variety of sensors of a table carrying-in sensor 21, a table carrying-out sensor 22, an intra-table sensor 23, and a table outlet sensor 24. As shown in FIG. 2, the table carrying-in sensor 21 is disposed at the carrying-in side of the transporting track such as the inter-process roller conveyor track 100. The table carrying-in sensor 21 enables suspending a carrying-in operation until a carrying-in preparation in the turntable 1 is completed by detecting the carrier 110 just before being carried in the turntable 1.

The table carrying-out sensor 22 is disposed at the carrying-out side of the transporting track. The table carrying-out sensor 22 allows the information processing part 29 to judge whether or not the carrier 110 is completely discharged from the turntable 1 by detecting the carrier 110 just after being carried out from the turntable 1.

The intra-table sensor 23 is disposed in each portion including the center portion of each block 2. The intra-table sensor 23 allows the information processing part 29 to judge whether or not the carrier 110 exists in the turntable 1 by detecting he carrier 110 existing in the turntable 1.

The table outlet sensor 24 is disposed on an outlet end surface B of the turntable 1. The table outlet sensor 24 enables suspending an carrying-out operation until an carrying-out preparation in the turntable 1 is completed by detecting the carrier 110 just before being carried out from the turntable 1.

(Roller Elevation Data Table)

Next, a detailed description of the roller elevation data table stored in the ROM part 34 will be given. The roller elevation data table stores data used for moving up and down the driving roller mechanism 31 and the driven roller mechanism 32 constituting the first track 3 and the second track 4 depending on the rotation angle (a table angle) of the turntable 1 and stores elevation data corresponding to rail numbers so as to move down the roller mechanisms 31 and 32 existing across the transport direction of the carrier 110 and move up the roller mechanisms 31 and 32 parallel to the transport direction.

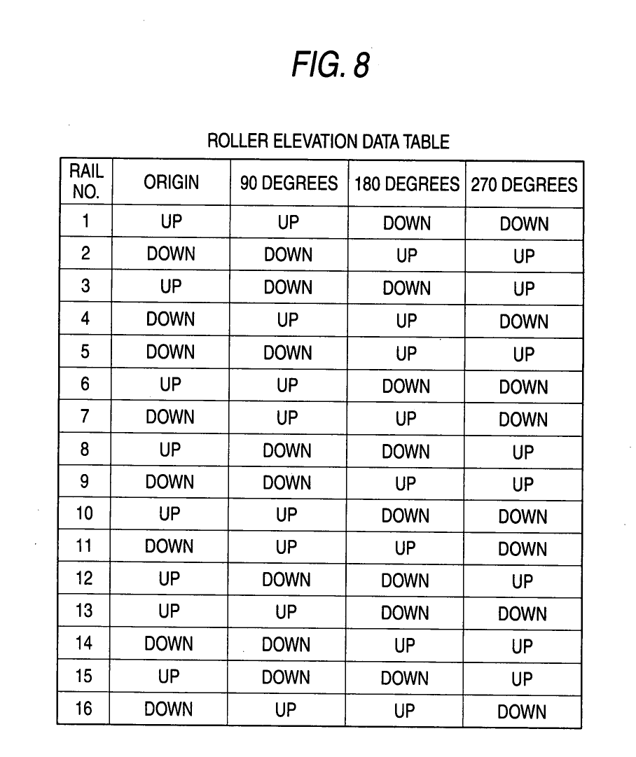

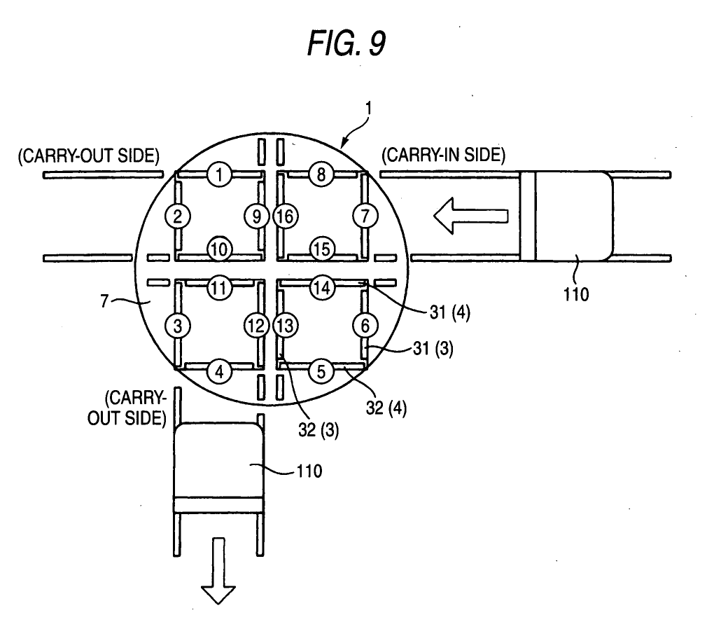

Specifically, as shown in FIG. 8, the roller elevation data table has a rail number column, and an origin column, a 90-degree column, a 180-degrees column, and a 270-degree column which serve as a table angle column. Rail number data is stored in the rail number column. As shown in FIG. 9, the rail number data includes specific rail numbers ‘1’ to ‘16’ given to the roller mechanisms 31 and 32 at an outer periphery side and an inner periphery side of the turntable 1. The origin column, the 90-degree column, the 180-degrees column, and the 270-degree column store the elevation data corresponding to the rail number data. The elevation data include two kinds of data such as “up” indicating an ascent of the roller mechanisms 31 and 32 and “down,” indicating a descent of the roller mechanisms 31 and 32. For example, in the roller mechanisms 31 and 32 of the rail number ‘1’, the turntable 1 ascends at an origin attitude (the origin) and a 90-degree attitude and descends at a 180-degree attitude (180 degrees) and a 270-degree attitude (270 degrees).

By this configuration, as shown in FIG. 9, the roller mechanisms 31 and 32 having the rail numbers of “7”, “16”, “9”, and “2” descends by the elevation data of “down” and the roller mechanisms 31 and 32 having the rail numbers of “8”, “1”, “15”, and “10” ascends by the elevation data of “up” when the turntable 1 receives the carrier 110 at the rotation attitude of the origin angle.

(Operation of Turntable 1)

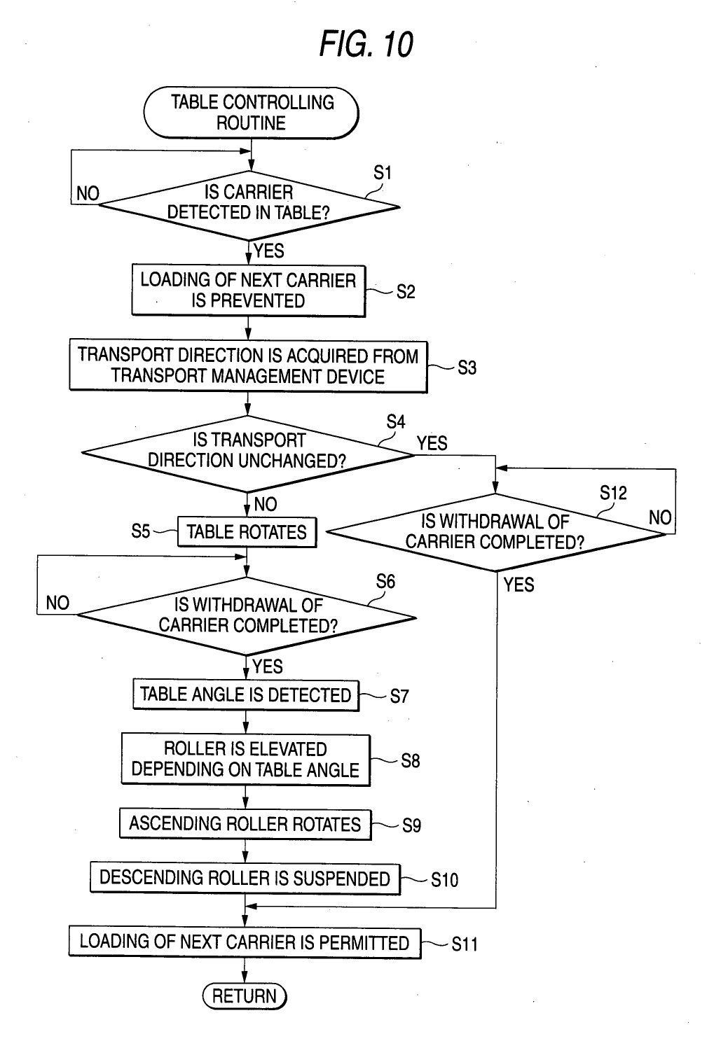

In the configuration described above, an operation of the turntable 1 will be described by using the table controlling routine shown in FIG. 10. First, as shown in FIG. 1, the carrier 110 is transported by the tracks 100, 101, and 103 and the ports 102 and 105 in the transport system. A current position or a transport location of each carrier 110 detected by various sensors not shown and is managed by the transport management device 37 shown in FIG. 7. When the carrier 110 reaches the turntable 1 in the transport system, the transport direction of the carrier 110 is held or changed so as to move toward the transport location of the carrier 110, whereby the transporting track is moved or bent in the turntable 1.

Specifically, as shown in FIG. 10, in the turntable 1, it is judged whether or not the carrier 110 is detected in the turntable 1 (S1). When the carrier 1 is not detected (S1, NO), it is judged that the carrier 110 is not carried in the turntable 1. Then, S1 is performed again and waits the carrying-in of the carrier 110. Meanwhile, when it is judged that the carrier 110 is detected (S1, YES), the entry of the next carrier 110 is prevented (S2). That is, for example, as shown in FIG. 2, when the carrier 110 transported from the inter-process roller conveyor track 100 reaches the upstream side (the carrying-in side) of the turntable 1, the transportation is suspended in the upstream position and a carrying-in standby mode is set. By this configuration, a plurality of carriers 110 is prevented from existing in the turntable 1.

Next, the transport direction of the carrier 110 carried in the turntable 1 is acquired by the data communication with the transport management device 37 (S3). It is judged whether or not the transport direction is held (S4). Since the transport direction of the carrier 110 disposed in the corner portion of the tracks 100, 101, and 103 shown in FIG. 1 can be just changed, the data communication with the transport management device 37 may be omitted.

As shown in FIG. 4, when the transport direction of the turntable 1 is held (S4, YES), the transport direction of the turntable 1 is held as same as that in a carrying-in status and it is judged whether or not the carrier 110 is withdrawn from the turntable 1 (S12). When the withdrawal is not completed (S12, NO), S12 is performed again. Meanwhile, when the withdrawal is completed (S12, YES), the entry of the next carrier 110 is permitted (S11). After this, after this routine is ended, a main routine not shown is performed in parallel with other processing routine. A process such as a direction change of the next carrier 110 is performed in S1 as shown in FIG. 2.

In S4, when it is judged in S4 that the transport direction is changed (S4, NO), the transportation of the carrier 110 is continued in the turntable 1 and the transport direction is changed by 90 degrees by the rotation of the table member 7 (S5) as shown in FIG. 5. By this configuration, for example, in FIG. 2, when the carrier 110 is carried in into the turntable 1 from the carrying-in side of the inter-process roller conveyor track 100 travels the turntable 1, the carrier 110 carried in into the turntable 1 from the carrying-in side of the inter-process roller conveyor track 100 is withdrawn from the carrying-out side of the communication roller conveyor track 103 by changing the transport direction by 90 degrees.

It is judged whether the withdrawal of the carrier 110 is completed (S6). The process of S6 is repeated until the withdrawal is completed. An elevating operation of the roller mechanisms 31 and 32 depending on the table angle (0 degree (the origin), 90 degrees, 180 degrees, and 270 degrees) is performed on the basis of the roller elevation data table shown in FIG. 8 (S8) by detecting the table angle of the table member 7 in the turntable 1 (S7). By this configuration, as shown in FIG. 2, when the direction change of the turntable 1 is completed and the inlet end portion A of other first track 3 or second track 4 communicates with the carrying-in side of the inter-process roller conveyor track 100, an attitude to receive the next carrier 110 is taken.

The rotation of the ascending roller mechanisms 31 and 32 is commenced (S9) and the rotation of the descending roller mechanisms 31 and 32 is suspended (S10). The entry of the next carrier 110 is permitted (S11) and this routine is ended. By this configuration, the carrier 110 waiting at the carrying-in side of the inter-process roller conveyor track 100 can be immediately carried in into the turntable 1 without waiting until the table member 7 is restored to an original status (a status before the rotation). As the result, the transportation of the transport system is smoothly performed as a whole.

(Overview of the Present Embodiment)

As shown in FIGS. 2 and 4, in the turntable 1 of the present embodiment, the turntable 1 capable of changing the transport direction of the transporting object (carrier 110) transported through the transporting track (the tracks 100, 101, and 103, and the ports 102 and 105) includes the plurality of intra-table tracks (the first track 3 and the second track 4) which have the inlet end portion A and the outlet end portion B which can communicate with the carrying-in side and the carrying-out side of the transporting track, respectively and transports the transporting object from the inlet end portion A to the outlet end portion B, the table member 7 including the intra-table tracks, the table rotating mechanism 8 suspendably rotating the table member 7 at an arbitrary rotation angle, and the table rotation controlling mechanism (the table controlling device 11) controlling the rotation of the table member 7 so as to set the transport direction of the transporting object transported through the intra-table tracks, wherein the intra-table tracks are disposed in the table member 7 so that the inlet end portion A of any one of the intra-table tracks communicate with the carrying-in side of the transporting track when the transport direction of the intra-table tracks are set.

By this configuration, when the transport direction of the intra-table track is set by rotating the table member 7, the outlet end portion B of the intra-table track communicates with the carrying-out side of the transporting track corresponding to the transport direction of the transporting object. The transport direction of the intra-table track is changed and the transporting object of the intra-table track is carried out to the transporting track existing at the carrying-out side (the downstream side of the transport direction), whereby it is possible to change the transport direction of the transporting object. At this time, the inlet end portion A communicates with the carrying-in side of the transporting track when the transport direction is set. Accordingly, even though a known restoring operation of restoring the intra-table track to a status before of the transport direction is set not performed, an operation of carrying-in the next transporting object existing at the carrying-in side of the transporting track into the intra-table track and changing the transport direction can be commenced in a short time.

The intra-table tracks are formed by a combination of the track blocks 2 each having the first track 3 (the driving roller mechanism 31 and the driven roller mechanism 32), transporting the transporting object, the second track 4 (the driving roller mechanism 31 and the driven roller mechanism 32) transporting the transporting object in a direction intersecting the transport direction of the first track 3, and the track elevating mechanism 5 selectively elevating the first track 3 and the second track 4.

By this configuration, since it is possible to easily complete an arrangement work of the intra-table track by the combination of the track blocks 2 and to intersect the intra-table tracks, it is possible to miniaturize the turntable 1. Even when the intra-table tracks intersect each other, the first track 3 and the second track 4 not used for the transportation may move down to a position lower than the second track 4 or the first track 3 used for the transportation. Accordingly, it is possible to prevent the both tracks 3 and 4 from being the obstacle in the transportation of the transporting object.

(Modified Example)

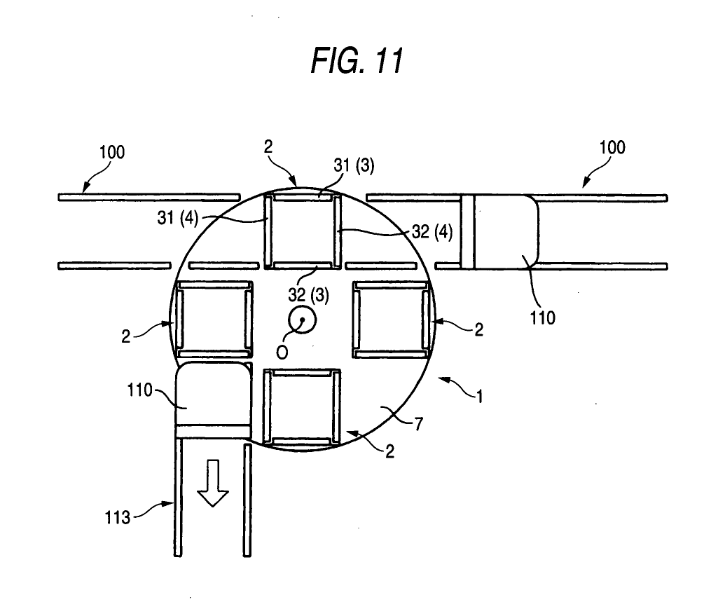

In the present embodiment, a case that the turntable 1 has the track blocks 2 arranged in the 2×2 matrix is described, but is not limited to the case. The turntable 1 may have a configuration shown in FIG. 11. Specifically, the four rectangular track blocks 2 are evenly disposed around the center portion O in a top view and are disposed so that the transport directions of the neighboring track blocks 2 and 2 are orthogonal to each other. The turntable 11 may have a configuration of a positional relationship in which other track blocks 2 are not located in the transport direction of each track block 2.

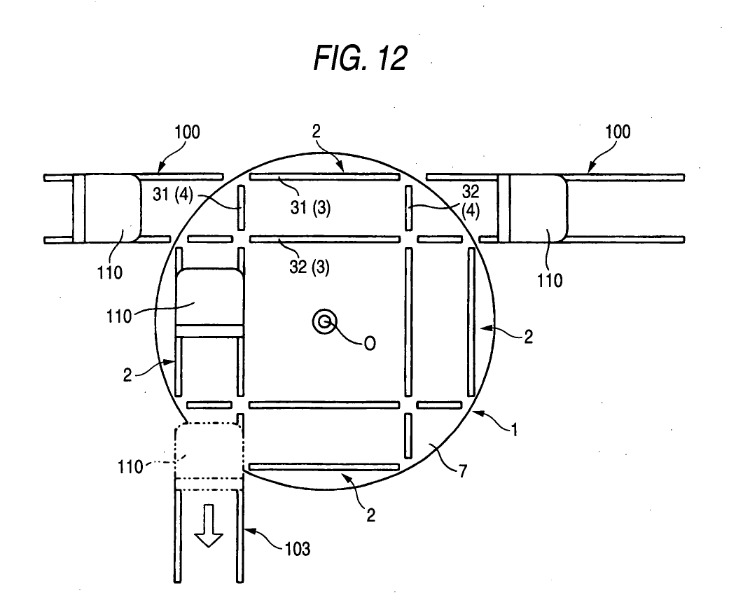

As shown in FIG. 12, in the turntable 1, the four rectangular track blocks 2 are evenly disposed around the center portion O in a top view and is disposed so that the transport directions of the neighboring track blocks 2 and 2 are orthogonal to each other. The turntable 11 may have a configuration of a positional relationship in which other track blocks 2 are not located in the transport direction of each track block 2.

In the present embodiment, the carrying-in and carrying-out of the carrier 110 with respect to the turntable I are performed at the timing when the succeeding carrier 110 is carried in the turntable 1 after the preceding carrier 110 existing in the turntable 1 is withdrawn, but the invention is not limited to the configuration.

That is, in the turntable 1, the turntable may include the transport controlling mechanism detecting that the setting of the transport direction of the preceding transporting object carried in the intra-table tracks is completed and carrying-in a succeeding transporting object in the intra-table tracks, and transporting the preceding transporting object to the outside of the table just after the setting is completed. By this configuration, when the completion of the setting of the transport direction on the intra-table track is detected, the preceding transporting object and the succeeding transporting object can be carried in and out with respect to the turntable at the same time. By this configuration, it becomes possible to resolve a standby time caused by a mismatch of a carrying-in timing and a carrying-out, thereby improve a transport efficiency in the turntable timing in that the succeeding transporting object can be carried in the turntable when the preceding transporting object exists in the turntable.

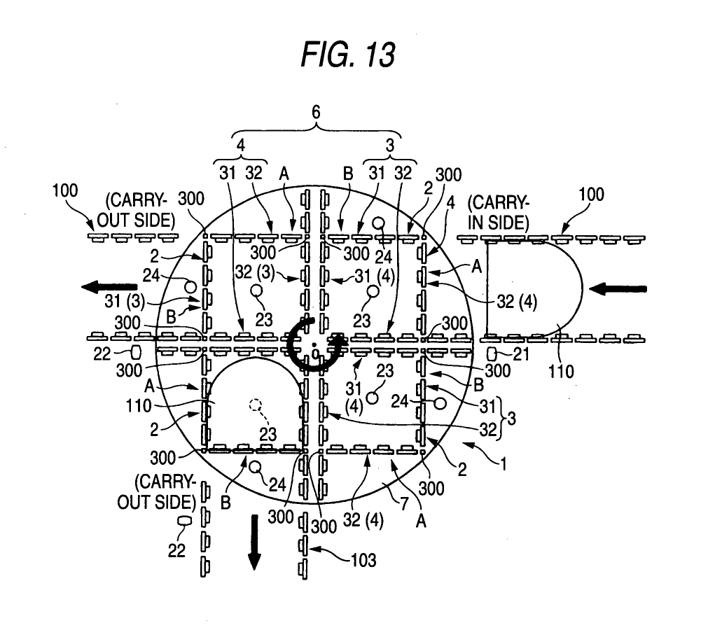

Specifically, as shown in FIG. 13, cargo sensors 300 detecting the carrier 110 are disposed at the carrying-in side and the carrying-out side of each track block 2. The disposition of the cargo sensors 300 in each track block 2 is set so that the carrier 110 is detected by the cargo sensors 300 at both the carrying-in side and the carrying-out side when the carrier 110 exists in the center portion of the track block 2. By this configuration, when the only cargo sensor 300 at the carrying-in side detects the carrier 110, it may be judged that the carrier 110 is carried in into the intra-table track of the track block 2. Meanwhile, when the only cargo sensor 300 at the carrying-out side detects the carrier 110, it may be judge that the carrier 110 is being withdrawn from the intra-table track of the track block 2.

Each cargo sensor 300 is connected to the information processing part 29 of FIG. 7 so as to output a detection signal. The information processing part 29 has a function of judging the entry or the withdrawal and the existence or the nonexistence of the carrier 110 on the basis of the detection signal from the cargo sensor 300 and a function as a transport controlling mechanism carrying-in the succeeding carrier 110 into the intra-table track and transporting the preceding carrier 110 to the area other than the table immediately after detecting the completion of the setting of the transport direction of the previous carrier 110 carried in the intra-table track.

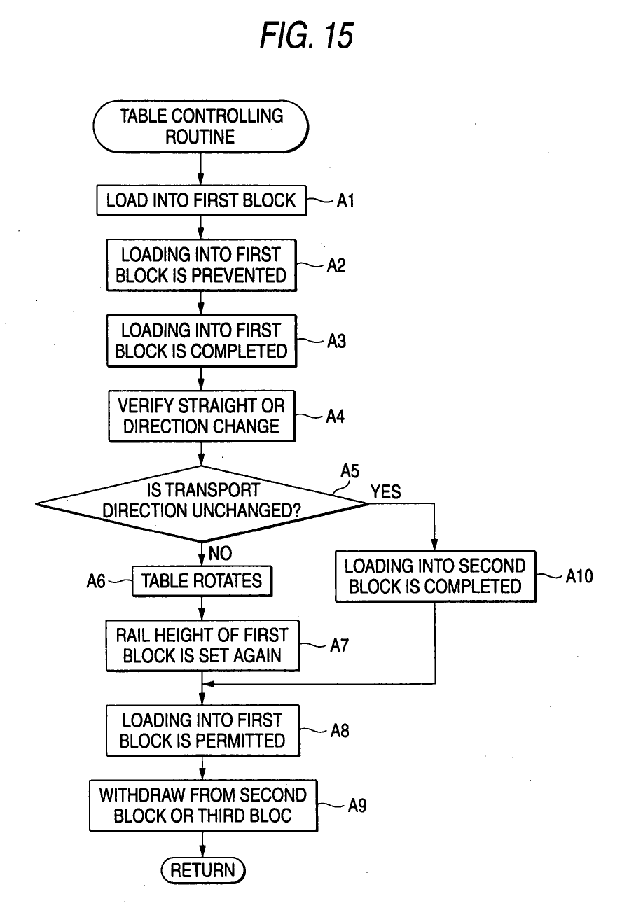

The function as the transport controlling mechanism is implemented by the table controlling routine of FIG. 15. That is, as shown in FIG. 13, the track block 2 located at the carrying-in side of the inter-process roller conveyor track 100 is set as the first block and the track blocks 2 located in a counterclockwise direction from the first block each are set as the second block, the third block, and the fourth block. The table controlling routine is performed during the setting operation.

First, the cargo sensor 300 at the carrying-in side senses that the carrier 110 is carried in into the first block of the turntable 1 (A1) and the succeeding carrier 110 is prevented from being carried in into the first block (A2). It is sensed that the carrier 110 is carried in into the track block is completed by the detection of the cargo sensors 300 and 300 at both sides (A3). Information on whether the carrier 110 is transported in an unchanged direction or in a changed direction is acquired (A4) and it is judged on the basis of the information whether the carrier 110 is transported in the unchanged direction or in the changed direction (A5). When the carrier 110 is transported in the unchanged direction (A5, YES), the carrier 110 is withdrawn from the first block and that the succeeding carrier 110 is immediately carried in into the first block is permitted (S8). By this configuration, the preceding carrier 110 moves from the first block to the second block and the succeeding carrier 110 is carried in into the turntable 1 before the preceding carrier 110 is withdrawn to the carrying-out side of the inter-process roller conveyor track 100 (S9).

Meanwhile, when the carrier 110 is transported in the changed direction (A5, NO), a rail height of a newly set first block is set again (A7) by rotating the table member 7 (A6) after the carrying-in into the second block is completed (A10) After the carrying-in of the carrier 110 into the second block is verified, the succeeding carrier 110 is permitted to be carried in into the first block (S8). By this configuration, the preceding carrier 110 moves from the first block to the second block while changing the direction by the rotation of the table member 7. The succeeding carrier 110 is carried in into the first block (S9) before the preceding carrier 110 is withdrawn to the carrying-out side of the inter-process roller conveyor track 100 from the second block.

As described above, the turntable 1 has the function as the transport controlling mechanism. Accordingly, at the time when the carrier 110 carried in into the first block is completely carried in into the second block, the succeeding carrier 110 can be immediately carried in in the first block when the transport direction is unchanged, and the carrier 110 can be carried in in the first block immediately after the direction change is completed when it is required that the transport direction is changed. As the result, in the turntable 1, it becomes possible to remarkably improve a transport rate in that the succeeding carrier 110 can be called in during the preceding carrier 110 exists on the table.

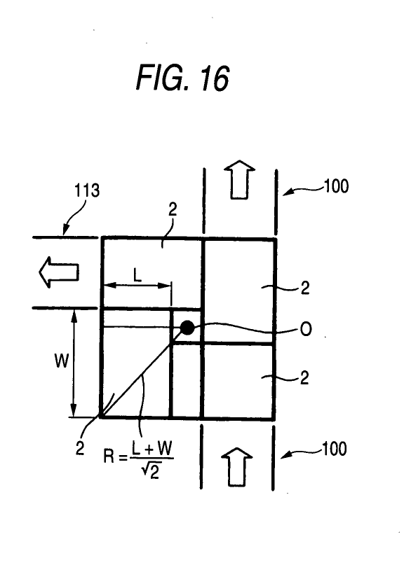

In the present embodiment, the turntable 1 may have a configuration shown in FIG. 16 when the track block 2 has a rectangular shape. Specifically, when a size of the track block 2 has a block length W and a block width L, a side surface of a neighboring other track block 2 faces a side surface of each track block 2 and the track blocks 2 may be evenly arranged in all directions from the center point O so that a distance R between an apex of each track block 2 serving as an apex of the turntable 1 and a center point O satisfies a relationship of (block length W+block width L)/\sqrt{2} adjacent to aside surface of each track block 2a side surface of other track block 2. In this case, it becomes possible to minimize an overall diameter of the turntable 1.

In the present embodiment, the power supply to the intra-table roller driving motor 48 installed on the track block 2, the driving motor 51 rotating the table member 7, or a motor of the track elevating mechanism 5 is performed by a commonly used technology such as a non-contact feeding method, a collector ring method, and the like, but the power supply may be performed by carrying-in a battery depending on the situation.

As described above, the present embodiment of the invention is described, but specific examples are simply exemplified. The present invention is not limited to the examples, but a pertinent design change may be performed in a concrete configuration. Operations and effects disclosed in the embodiment of the invention simply represent the most suitable operations and effects occurring in the invention, but are not limited to the operations and effects disclosed in the embodiment of the invention.

What is claimed is:

1. A turntable which changes a transport direction of a transporting object transported through a transporting track, comprising:
a plurality of intra-table tracks, each of which comprising:
an inlet end portion that is capable of communicating with a carrying-in side of the transporting track; and
an outlet end portion that is capable of communicating with a carrying-out side of the transporting track,
wherein the transporting object is transported from the inlet end portion to the outlet end portion;
a table member on which the intra-table tracks are provided;
a table rotating mechanism that rotates the table member to be stopped at an arbitrary rotation angle; and
a table rotation controlling mechanism that controls the rotation of the table member so as to set the transport direction of the transporting object transported through the intra-table tracks,
wherein the intra-table tracks are disposed in the table member so that when a transport direction of one of the intra-table tracks is set, the inlet end portion of any other intra-table tracks communicates with the carrying-in side of the transporting track.

2. The turntable according to claim 1, wherein the intra-table tracks comprise a plurality of track blocks each comprising:
a first track transporting the transporting object;
a second track transporting the transporting object in a direction intersecting the transport direction of the first track; and
a track elevating mechanism that selectively elevates the first track and the second track,
wherein the intra-table tracks are formed by a combination of the track blocks.

3. The turntable according to claim 1, further comprising a transport controlling mechanism that controls so that:
detecting a completion of setting the transport direction of a preceding transporting object carried in the intra-table tracks,
carrying-in a succeeding transporting object into the intra-table tracks, and simultaneously, transporting the preceding transporting object to the outside of the turntable just after the setting is completed.

4. A turntable which changes a transport direction of a transporting object transported through a transporting track, comprising:
a plurality of intra-table tracks, each of which comprising:
an inlet end portion that is capable of communicating with a carrying-in side of the transporting track; and
an outlet end portion that is capable of communicating with a carrying-out side of the transporting track,
wherein the transporting object is transported from the inlet end portion to the outlet end portion;
a table member on which the intra-table tracks are provided;
a table rotating mechanism that rotates the table member; and
a table rotation controlling mechanism that controls in such a manner that:
carring in the transporting object from the carrying-in side of the transporting track to the inlet end of one of the intra-table tracks;
rotating the table member so that the outlet end of one of the intra-table tracks is positioned at the carring-out side of the transporting track, and the inlet end of another intra-table tracks is positioned at the carring-in side of the transporting track.

5. The turntable according to claim 4, wherein the intra-table tracks comprise a plurality of track blocks each comprising:
a first track transporting the transporting object;
a second track transporting the transporting object in a direction intersecting the transport direction of the first track; and
a track elevating mechanism that selectively elevates the first track and the second track,
wherein the intra-table tracks are formed by a combination of the track blocks.

6. The turntable according to claim 4, further comprising a transport controlling mechanism that controls so that:
detecting a completion of the rotating of the table member,
carrying-in a succeeding transporting object into the another intra-table tracks, and simultaneously, transporting a preceding transporting object to the carrying-out side of the transporting track just after the rotation of table member is completed.
